(19) United States
(12) Patent Application Publication
(10) Pub. No.: US 2006/0023741 A1
(43) Pub. Date: Feb. 2, 2006

(54) Adaptive control of a network element

(76) Inventors: Joachim Charzinski, Munchen (DE); Karl Schrodi, Geretsried (DE); Christian Winkler, Munchen (DE)

Correspondence Address: Siemens Corporation;Intellectual Property Department, 170 Wood Avenue South, Iselin, NJ, 08830, US

(21) Appl. No.: 10/519,140

(22) PCT Filed: Jun. 20, 2003
(86) PCT No.: PCT/EP03/06538

§ 371 Date: Dec. 22, 2004

(30) Foreign Application Priority Data
Jul. 26, 2002 (EP) 02014001.8
Nov. 29, 2002 (DE) 102-55-922.8

(51) Int. Cl. H04J 3/22

(52) U.S. Cl. 370/465; 370/252

(57) ABSTRACT

The invention relates to the autonomous, adaptive control of a network element in a packet-oriented and connection-less communication network, and to the coupling of a plurality of network elements.

The object of the application relates to a method for adaptive control of a network element in a communication network and a method for coupling a plurality of network elements.

It gives the concept for configuring network nodes using rules which have been predefined by an administrator and stored in a database. This ‘policy based networking’ of the IETF (Internet Engineering Task Force) is used on the one hand to load quasi-static configuration information into the network nodes. On the other hand, it can also be used to give configurations, which need to be set depending on concrete connection requests, to the nodes at the time they are requested. To this end, a component that is superordinate to the network, the ‘Policy Decision Point’ (PDP), is introduced which is able to read the predefined rules from the database and to seek out the rule suitable for the given situation. It then loads corresponding configuration information into the network element PEP (stands for: ‘Policy Enforcement Point’).

If the PDP is used only for the static configuration, it is no longer involved during normal operation of the network. From that point in time the nodes operate independently of the network control facility, but they are not able to react independently. However, if incoming connection requests are to be processed (for example RSVP, Resource Reservation Protocol), then the PDP is the central component of network operation. The rules in the database of the PDP are created by an administrator, automatically checked for consistency if need be, and prioritized by the PDP in accordance with predefined schemes in the event of conflicts.

The object of the invention is to set down a method for control of a network element in a communication network which reacts in the event of changing operating conditions such as changing load, line interruption or node failure for example, by quickly and autonomously forwarding data packets.

This object is achieved by a method having the features described in Claim 1.

According to the invention, a network element is controlled in an autonomous communication network by way of behavior rules. To this end a control entity, the ‘Network Control Server’ (NCS), which creates these rules and thus configures the network element is assigned to the network element. This approach means that the network functions without the continuous intervention of the NCS. Only when new, adapted rules are required as a result of lasting, long-term changes in the network situation does the NCS provide the network element with corresponding new information.

Based on the knowledge that the greater the level of administrative effort required in order to operate a network the higher are the costs caused, the approach according to the invention which uses autonomously operating network elements is advantageous from the outset. The method described here of generating the rules automatically minimizes the operator costs whilst simultaneously enhancing the availability. By coupling NCS's of a plurality of network elements it is also possible to operate (sub-)networks on a higher level and to represent the end-to-end quality characteristics required by the user with a minimum of administrative effort.

The invention exhibits the following characteristics:
The network operates in a packet-oriented and connectionless manner.
The network comprises network elements which operate autonomously with the use of rules.
With the aid of these rules the network elements are able to autonomously effect the forwarding of packets during normal operation in accordance with predefined criteria (quality of service for example), particularly also by way of a plurality of appropriate possible paths (for example in order to provide even load distribution). Moreover, they react autonomously very quickly to failures in the network (line interruption or node failure for example).

In a special embodiment of the invention the behavior rules are formed and made available in a control entity (NCS) assigned individually to a network element. In this situation, in a communication network comprising a plurality of network elements, one, several or all network elements generate behavior rules for themselves in each case, from which the said network element autonomously/independently makes a selection according to the operating conditions.

An embodiment in which a network element has an individually assigned control entity (NCS) is incorporated into the concept of a non-hierarchical network architecture in which the network element in question has the full functionality at its disposal. In this situation, a network element thus has the functionality of the control entity (NCS), comparable with the link-state information made available in the network element, relating to the availability of the connected link lines.

Advantageous developments of the object of the application are set down in the subclaims.

The invention will be described in detail in the following as an embodiment in a scope required for comprehension with reference to the drawings. In the drawings:

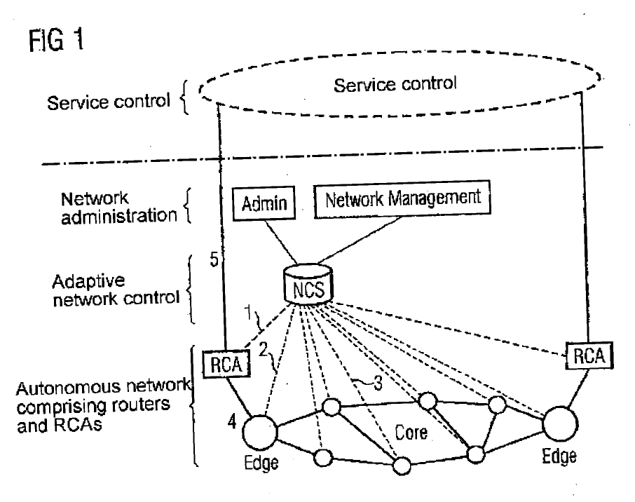

FIG. 1 shows a schematic representation of the network elements according to the invention in the communication network,

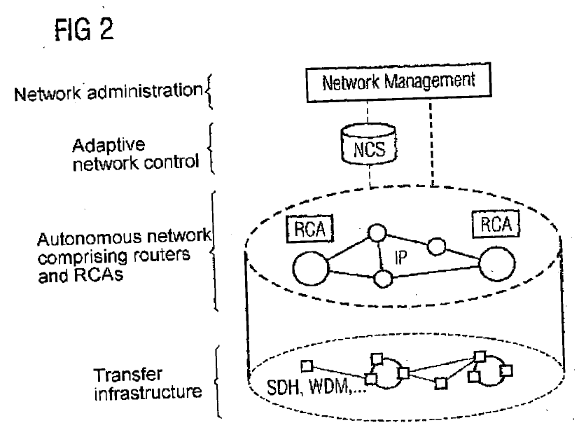

FIG. 2 shows a schematic representation of the network and control hierarchy, and

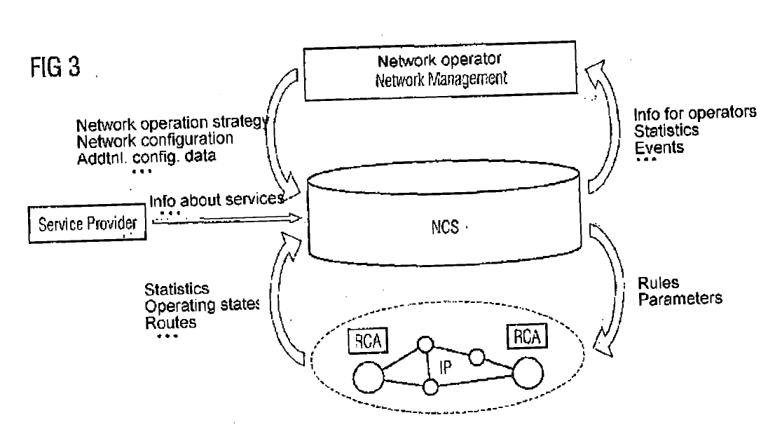

FIG. 3 shows input and output variables for adaptive network control.

In the figures, the same designations are used for the same elements.

The invention represented here describes adaptive control. In addition, it addresses the coupling of a plurality of networks.

The network elements acting autonomously according to the invention in a network (referred to in the following as an autonomous network) operate under the guidance of an adaptive control facility but without its continuous intervention.

The elements in the autonomous network (see FIG. 1) comprise:
on the one hand the network nodes which switch/forward the traffic autonomously (routers), which are differentiated as edge routers and core routers,
on the other hand the resource control agents (RCA) which are located at the network edge.

The RCAs are assigned to the edge nodes. It is their task to receive resource requests (connection establishment/cleardown for example) made to an assigned input or output edge node (for example from a separate services control facility, not described in detail here (see FIG. 1, \textcircled{5}) to check whether they are admissible and can be satisfied, and to accept or reject them. The RCA subsequently provides the corresponding edge node with parameters (see FIG. 1, \textcircled{4}) which enable the edge node to set up the usage and usage monitoring of the resources and to configure the rules for handling the data packets associated with the corresponding traffic flow (for example marking, policing, scheduling).

The RCAs operate autonomously like the routers on the basis of behavior rules. These behavior rules describe their control function and explicitly or implicitly (for example as a calculation specification) contain the parameters which are to be passed on to the edge routers during operation.

A plurality of options exists for implementing an RCA:
as a separate server,
integrated into an edge router

In this situation, one RCA can be responsible for:
a single edge router
a plurality of edge routers

The elements (routers, RCAs) comprising the autonomous network operate in accordance with behavior rules. These can be issued by the NCS to the network elements or can also configured elsewhere, for example by way of the network management facility. The NCS can thus be responsible for:
core routers (see FIG. 1, \textcircled{3})
edge routers (see FIG. 1, \textcircled{2})
RCAs (see FIG. 1, \textcircled{1})
any combination
   Network and Control Hierarchy

The network and control hierarchy comprises four levels which each have different points of emphasis/objectives in respect of control functions and different timing characteristics. From bottom to top these are (cf. FIG. 2):
the transfer infrastructure/transmission
the autonomous IP network
the adaptive control of the network elements
the network management

The transfer infrastructure is primarily responsible for the transmission of data and may contain mechanisms for providing very fast alternate routing in the event of a fault (for example, line interruption etc.), for example with regard to SDH or similar approaches in the field of optical networks. This is a control function which is executed independently by the transfer infrastructure within milliseconds.

The autonomous IP network described above autonomously processes resource requests, a control function in cooperation with a service control facility, distributes the traffic on the network and reacts quickly and independently to fault instances. In this situation, only those faults are processed which could not actually be recovered on the transmission level.

In contrast to the two lower levels, the adaptive network control (regulation) facility according to the invention has no realtime requirements. It observes the network and creates new rules in the event of significant deviations from desired operational conditions. The time horizon lies in the range of hours or above.

In the direction of the network, the network management facility serves to set up the basic configuration. As a general rule, it will therefore only exert an active control function at very great time intervals, in the case of extension of the network for example.

A plurality of options exists for implementing an NCS:
as a separate server
assigned to a respective network element, integrated for example

In this situation, one NCS can be responsible for:
a single network element
a plurality of network elements
   Rules and Rule Creation

A. Quasi-Static Rules:

In the simplest case these rules are quasi-static, in other words they depend only on the network topology and the static properties of the network.

In contrast to ‘policy based networking’, they are however not definitely specified by an administrator but are created automatically by the NCS.

The NCS can obtain the basic information for this purpose from network management and/or from the network elements itself/themselves, for example. This information can include: network topology, line bandwidths, properties of the network element or elements, (preferred) routes, traffic matrixes, traffic classes etc.

In the event of changes in this basic information, for example changes to the network topology, the rules are accordingly recalculated and loaded into the relevant network element.

The rules are defined in such a way that the network is able to guarantee the properties described above in autonomous operation. The NCS is fundamentally not part of the regulation mechanism.

B. Dynamic Rules:

In this more complex case, the rules are in addition adaptively changed or adapted or created depending on the network status. In this situation, it should be emphasized that the rules are adapted in a fairly wide time scale (15 minutes or 2 days, for example) and the network continues to quickly react autonomously to dynamic changes (including faults) as before.

Two variants are conceivable for rule creation by the NCS:
The NCS selects rules from a set of predetermined rules according to the network situation.
The NCS additionally adapts the predetermined rules according to the network situation.
The NCS creates rules according to the network situation.

Information from the network includes for example statistics relating to the traffic and the queues, fault messages from the network, current routing etc. It is thus possible, for example, to correct the threat of long-lasting unbalanced loads (caused for example by extended failures or a permanent change in user behavior and the traffic matrixes).

Information Level and Intelligence of the ‘NCS’:

Graduated embodiments differing in the dimensions of information level and intelligence are possible for the NCS. The more information (sources) available to the NCS, the better optimized are the rules that it can create. Closely interlinked with this is the necessary and possible intelligence of the NCS which can be embodied as anything from simple logic, through optimization methods and dimensioning methods, right up to expert systems or neural networks. As the information level increases, so too does the intelligence requirement for the NCS.

Possible information sources (also in different combinations) include the network elements themselves (for example: statistical information, network load, routes), the network management facility (for example: topology, fault events), administrator inputs, static and dynamic basic data (for example: traffic matrixes).

Information flows from/to the adaptive network control facility (NCS):

The NCS draws information from a plurality of sources in order to perform its function and also delivers data to different recipients (cf. FIG. 3).

Input:
Network management/operators (amongst others):
Network operation strategy
Network configuration
Additional configuration data (for example, network segments requiring special protection or similar)
Autonomous network (amongst others):
Statistics
Operational states
Routes
Service providers (amongst others):
Information about services and applications and their properties and requirements

Output:
Network management/operators (amongst others):
Information for operators, for example the need for network expansion etc.
Statistics
Events
Autonomous network (amongst others)
Behavior rules
Parameters
   Coupling of (Sub-)Networks

If a plurality of networks which are operating in accordance with the autonomous principle described are to be closely coupled such that they are able to globally represent the properties of the autonomous network such as load distribution, fault response and quality of service, the rules for the sub-networks must be matched with one another.

To this end the NCS's, each of which is responsible for a (sub-)network, are coupled with one another by means of a suitable protocol and exchange information in order to harmonize the rules. Subsequently, as described above, they create adapted rules and use these to support the network elements of their (sub-)network.

Options and Extensions

Each network node receives an individual set of parameters/all network nodes receive the same parameter.
The parameters also contain the selection of one algorithm when a plurality of algorithms comes into consideration for handling the function.
The NCS can be located centrally in the network/there is one or more backup facilities/there is a plurality of equal-ranking coordination facilities which harmonize their rule specifications with the aid of a special coordination protocol/different areas of the network or more precisely network elements are controlled locally by different NCS's which communicate by way of a special communication protocol.
The change in the rules takes place depending on the loading of one or more links.
The change in the rules takes place depending on an observed quality of service.
The change in the rules takes place depending on queue lengths observed in the network nodes.
The NCS is used in order to additionally define the parameters in facilities for controlling connection acceptance at the network edge.
The NCS communicates with other Network Control Servers in the networks of other network operators.
From the status information available to it (and possibly from further parameters supplied by network management), the NCS generates current tariff information which it passes on to transport control (RCAs).
The communication between network elements and NCS can be initiated by the NCS or by the network elements. In the former case, the NCS actively supplies the network elements with new rules and/or parameters as soon as these are available. In the latter case, the network elements can call down the current rules/parameters when required. Both forms of communication can be used in one network, whereby the second presents itself particularly within the framework of an automatic configuration of new network elements (during commissioning or a restart, for example) and/or for configuration of the communication parameters for the first communication form.
When creating the rules/parameters, the NCS takes into consideration the sequence in which the new rules/parameters are loaded into the network elements. Since not all network elements are able to receive new rules/parameters at absolutely the same time, such an intelligent coupling of creation and distribution of the rules/parameters can help to avoid transient states of overload or instability.

1.-9. (canceled)

10. A method for controlling a network element in a communication network, the method comprising:
providing a plurality of behavior rules by the network element;
selecting a behavior rule according to operating conditions by the network element; and
forwarding data packets in accordance with the selected behavior rule by the network element.

11. The method according to claim 10, wherein the operating conditions are given by any combination of line interruption, node failure, network loading, connection establishment, or network reconfiguration.

12. The method according to claim 10, wherein a behavior rule contains a selection of one of a plurality of paths.

13. The method according to claim 11, wherein a behavior rule contains a selection of one of a plurality of paths.

14. The method according to claim 10, wherein the behavior rules are made in a control entity.

15. The method according to claim 11, wherein the behavior rules are made in a control entity.

16. The method according to claim 12, wherein the behavior rules are made in a control entity.

17. The method according to claim 10, wherein the behavior rules are formed in a control entity individually assigned to a network element.

18. The method according to claim 11, wherein the behavior rules are formed in a control entity individually assigned to a network element.

19. The method according to claim 10, wherein the behavior rules can be delivered to the network element by way of network management from a control entity superordinated to a plurality of network elements.

20. The method according to claim 11, wherein the behavior rules can be delivered to the network element by way of network management from a control entity superordinated to a plurality of network elements.

21. The method according to claim 10, wherein the behavior rules are created automatically.

22. The method according to claim 11, wherein the behavior rules are created automatically.

23. The method according to claim 12, wherein the behavior rules are created automatically.

24. The method according to claim 10, wherein the method is used in a packet-oriented and/or connectionless communication network.

25. The method according to claim 10, wherein the network element autonomously or independently selects a behavior rule according to the operating conditions.

26. A method for coupling a plurality of network elements, comprising:
providing control entities, each assigned to a network element; and
coupling two control entities by a protocol by way of which they exchange information for the harmonization of behavior rules.

27. A method for coupling a plurality of network elements, comprising:
providing control entities, each assigned to a network element;
providing a plurality of behavior rules by the network element;
selecting a behavior rule according to operating conditions by the network element;
forwarding data packets in accordance with the selected behavior rule by the network element; and
coupling two control entities by a protocol by way of which they exchange information for the harmonization of behavior rules.

28. The method according to claim 27, wherein the method is used in a packet-oriented and/or connectionless communication network.

29. The method according to claim 27, wherein the network element autonomously or independently selects a behavior rule according to the operating conditions.
